(19) United States
(12) Patent Application Publication
(10) Pub. No.: US 2017/0055041 A1
(43) Pub. Date: Feb. 23, 2017

(54) INTERACTIVE ACKNOWLEDGE SYSTEM AND METHOD BASED ON INTERNET COMMUNICATIONS AND STREAMING MEDIA LIVE BROADCAST

(71) Applicant: Daxin Zhu, Shenzhen (CN)

(72) Inventor: Daxin Zhu, Shenzhen (CN)

(21) Appl. No.: 15/308,054

(22) PCT Filed: Aug. 22, 2014
(86) PCT No.: PCT/CN2014/000786

§ 371 Date: Oct. 31, 2016

(30) Foreign Application Priority Data
May 7, 2014 (CN) 201410191785.5

(51) Int. Cl. H04N 21/6583; H04N 21/61; H04N 21/643; H04N 21/234; H04N 21/235; H04L 29/06; H04N 21/2187

(52) U.S. Cl. CPC H04N 21/6583; H04L 65/4076; H04L 65/1006; H04N 21/6125; H04N 21/6175; H04N 21/2187; H04N 21/234; H04N 21/235; H04N 21/643; H04L 67/02

(57) ABSTRACT

This invention discloses an interactive acknowledge system and method based on internet communications and streaming media live broadcast, wherein the interactive acknowledge system based on internet communications and streaming media live broadcast includes: an interactive acknowledge publishing client comprising a streaming media data reading module, an interactive acknowledge editing and initiating module and a publishing module, an interactive acknowledge server comprising an interactive acknowledge delivery processing module, an interactive acknowledge delivery strategy judging module and a client delivery module, and an interactive acknowledge client comprising an interactive acknowledge processing module and an interactive acknowledge display and data collection module. The system edits and delivers interactive acknowledge logic or sends out a real-time interactive acknowledge request, is triggered according to a triggering condition, collects and reports acknowledge data, thus realizing a good interaction with audience. Comparing the delivery time axis with the reporting time axis can better control the delay.

### TECHNICAL FIELD

The present invention relates to the multimedia technology field in the communications industry, and more particularly to an interactive acknowledge system and method based on internet communications and streaming media live broadcast.

### BACKGROUND

The internet-based streaming media technology adopts the streaming transport method to transfer multimedia files over the internet, publishes and stores compressed multimedia information such as continuous audio/videos into the internet media server so that the internet client can run playback when downloading without waiting for the completion of the downloading process. The streaming media live broadcast can use the streaming technology to publish and transfer the media information collected when audio-video information is being collected to enable the client to play back such media information being collected using the internet time lag.

The existing internet streaming media live broadcast is realized through the following main processes: collection and encoding: collect the audio-video information, and use the specific encoding algorithm to compress the audio and video information; combination: use a specific container format to combine the encoded audio-video information into a specific streaming file container; publishing: use a specific transport and control protocol to stream the files to the internet media server; delivery: By adopting a specific transport and control protocol, the client download the streaming media from the internet media server; and playback: the client will decode and reproduce the audio-video information collected based on the streaming file container and the encoding algorithm used for audio-video information.

In the field of internet, especially the mobile internet, the technology, standards and schemes used for different processes of the streaming media live broadcast are as follows: the audio encoding methods include: AMR, AAC, MP3, Vorbis, etc; the video encoding methods include MPEG-2, MPEG-4, H.263, H.265, VP6/8, etc; the file containers include: MP4, 3GPP, FLV, ASF, WebM, MPEG-TS, etc.; the streaming publishing methods completely depend on the realization of the streaming server, and different protocols may be used according to the realization of the streaming server, such as RTP, RTMP or private protocols. The protocols widely adopted for the delivery of streaming media include: HLS, RTP/RTSP, RTMP, MMS, etc; the client performs playback using various media players such as Flash Player, players built in HTML5-support browsers, players built in the Iphone/iPad and Android-based mobile platforms and other player apps.

As shown in FIG. 1, the existing internet-based streaming media live broadcast systems include a publishing client, a server and a player client. The publishing client uses HTTP to interact with the server and upload the partitioned streaming media to the server; the server combines and stores the said partitioned streaming media into streaming segments according to the streaming segment time set, and create a number of indexes for streaming segment sequences; the player client uses HTTP to interact with the server and download the streaming segments from the server according to the index sequences for playing. The said existing internet-based streaming media live broadcast system is easy to be realized in various internet or mobile internet smart platforms, featuring in high robustness and fault tolerance, and possibility of realizing the large-scale deployment over internet and CDN deployment. Although the said system is capable of broadcasting streaming media online, it is unable to realize the real-time interaction between audiences and streaming media, thus restricting the enthusiasm of audience, the interactivity with programs and the innovation of programs.

In addition, for the purpose of saving bandwidth, the P2P technology is usually adopted for the real-time broadcasting of video streaming media, namely the point-to-point technology. When connecting the streaming server to download the streaming media contents, the streaming player client will report the network segment it is located, the routing table and UL/DL bandwidths to the streaming server. After such data is received, the streaming server will send back other clients located in neighboring network segments with similar routing tables, and access the same streaming media content partitions between these clients through P2P between neighboring clients, namely the P2P technology. Due to the continuity and consistency of live contents, there is a high possibility that same streaming content partitions exist between neighboring clients so that the quantity of data delivered from the streaming server can be greatly saved, thus reducing the bandwidth burden of the streaming server. However, the streaming contents should be indexed and partitioned to different clients to download if this method is used, and the client will synthetize and process the streaming partitions again after they are received. As a result, the transport quality from point to point between different clients can't be assured sometimes, thus resulting in the increase in processing time and some unreliable factors, and reducing the play quality of client.

The said existing technology can basically meet the need for the real-time transport and broadcast of audio-video signals based on internet. However, the existing technology has the following two major defects in light of application:
1. Time delay: generally, the delay time between the live broadcast signal source and the player client is 6-10 seconds, but when distributed in a large scale to more than 10000 users, the delay time may increase to 15-35 seconds or more because the P2P technology will always be used considering the bandwidth pressure.
2. Inability of audience to interact: A live event or content may be of time essence and ornamental nature, such as accidents, major sports games, concerts, entertainment programs, etc. At present, the only way for user to interact with each other is in writing, providing a poor real-time performance, and resulting in difficulties to feed back the comments to the live broadcast site. A program will become more interactive, meaningful and attractive to audience if they can participate in the live broadcast site or the preparation and broadcasting process of the contents in a real-time manner through internet-based means and by ways of writing, image, voice and even video.

### DESCRIPTION OF THE INVENTION

The purpose of the present invention is to provide an interactive acknowledge system and method with a better time delay performance, which can provide real-time interaction between audience and signal source by means of internet communications.

The technical solution adopted by the invention to solve the technical problems is:

An interactive acknowledge system based on internet communications and streaming media live broadcast, comprising: a data collection and synthesis station, and also including: an interactive acknowledge publishing client, an interactive acknowledge server and an interactive acknowledge client;

The said interactive acknowledge publishing client comprises: a streaming media data reading module and an interactive acknowledge editing and initiating module and a publishing module; the said streaming media data reading module is used to read audio-video signals from the said data collection and synthesis station and the time axis data corresponding to the audio-video signals; the said interactive acknowledge editing and initiating module is used to define and edit the interactive acknowledge logic for interaction or send a real-time interactive acknowledge request for interaction, and set the said interactive acknowledge logic or the delivery strategy for the real-time interactive acknowledge request; the said publishing module is used to upload the said interactive acknowledge logic or the said real-time interactive acknowledge request, the delivery strategy and the time axis data to the said interactive acknowledge server;

The said interactive acknowledge server includes: an interactive acknowledge delivery processing module, an interactive acknowledge delivery strategy judgement module and a client delivery module; the said interactive acknowledge delivery processing module is used to receive the said interactive acknowledge logic or the real-time interactive acknowledge request and the time axis data uploaded; the said interactive acknowledge delivery strategy judgement module is used to receive the said delivery strategy uploaded and to verify and judge the delivery strategy; the client delivery module is used to deliver the said interactive acknowledge logic or the real-time interactive acknowledge request and the time axis data to the interactive acknowledge client;

The said interactive acknowledge client includes: an interactive processing module and an interactive acknowledge display and data collection module; the said interactive acknowledge processing module is used to receive the said interactive acknowledge logic or the real-time acknowledge request, and to trigger the interactive acknowledge logic or the real-time interactive acknowledge request according to the triggering conditions; the said interactive acknowledge display and data collection module is used to receive the time axis data, collect and process the acknowledge data, and report the said acknowledge data and the time axis data to the said data collection and synthesis station.

the said interactive acknowledge editing and initiating module defines and edits the interactive acknowledge logic used for interactions or sends out the real-time interactive acknowledge request used for interactions, sets the said interactive acknowledge logic or the delivery strategy for the said real-time interactive acknowledge request, and transmits the said interactive acknowledge logic or the real-time acknowledge request and the delivery strategy to the said publishing module which will upload the said interactive acknowledge logic or the real-time interactive acknowledge request and the delivery strategy to the said interactive acknowledge delivery processing module and the interactive acknowledge delivery strategy judgement module; the said interactive acknowledge delivery strategy judgement module receives the delivery strategy uploaded, verifies and judges the said strategy and send it to the said client delivery module after verification, and the said interactive acknowledge delivery processing module receives the said interactive acknowledge logic or the real-time interactive acknowledge request uploaded and send such interactive acknowledge logic or such real-time acknowledge request received to the said client delivery module which will deliver the said interactive acknowledge logic or the real-time interactive acknowledge request to the said interactive acknowledge client according to the verified delivery strategy; the said interactive acknowledge processing module receives the said interactive acknowledge logic or the real-time acknowledge request and triggers the said interactive acknowledge logic or the real-time acknowledge request according to the triggering conditions and transmit the acknowledge data to the said interactive acknowledge display and data collection module which is used to receive the time axis data, collect and process acknowledge data and report the said time axis data and the acknowledge data to the said data collection and synthesis station.

The said interactive acknowledge editing and initiating module includes an interactive acknowledge logic editing module, and the said interactive acknowledge processing module includes an interactive acknowledge logic processing module;

The said interactive acknowledge logic editing module predefines and pre-edits the interactive acknowledge logic used for interactions, sets the delivery strategy for the said interactive acknowledge logic and transmits the said interactive acknowledge logic and its delivery strategy to the said publishing module, and the said publishing module uploads the said interactive acknowledge logic and its delivery strategy to the said interactive acknowledge server; the said interactive acknowledge delivery strategy judgement module receives the delivery strategy uploaded, verifies and judges the said delivery strategy and send the verified delivery strategy to the said client delivery module. The said interactive acknowledge delivery processing module receives the said interactive acknowledge logic uploaded and transmits the said interactive acknowledge logic received to the said client delivery module; the said client delivery module delivers the said interactive acknowledge logic to the said interactive acknowledge logic processing module according to the said delivery strategy verified; the said interactive acknowledge logic processing module receives the said interactive acknowledge logic and pre-store it; the said streaming media data reading module reads the audio-video signals and the time axis data corresponding to the audio-video signals and transfers the said time axis data to the said publishing module, and the said publishing module transfers the said time axis data to the said interactive acknowledge server which delivers the said time axis data to the said interactive acknowledge logic processing module according to the delivery strategy stored after verification, and the said interactive acknowledge logic processing module triggers the said interactive acknowledge logic according to the time axis data and report the acknowledge data in respect of the said interactive acknowledge logic to the said data collection and synthesis station.

The said interactive acknowledge logic editing and initiating module includes an real-time interactive acknowledge request initiating module, and the said interactive acknowledge processing module includes a real-time interactive acknowledge request processing module; the said real-time interactive acknowledge request initiating module receives and sends the real-time interactive acknowledge request used for the interaction purpose to the said publishing module, and the said publishing module upload the real-time interactive acknowledge request received and the delivery strategy to the said interactive acknowledge server; the said interactive acknowledge server receives the real-time interactive acknowledge request and the deliver strategy uploaded, verifies and judges the said delivery strategy and delivers the said real-time interactive acknowledge request to the said real-time interactive acknowledge request processing module according to the said delivery strategy verified; the said real-time interactive acknowledge request processing module receives and triggers the real-time interactive acknowledge request and reports the acknowledge data in respect of the said real-time interactive acknowledge request to the said data collection and synthesis station.

The said data collection and synthesis station is used to collect multi-input source data and to output such data after edited, processed and synthetized in a real-time manner together with the time axis data to the said streaming media data reading module, or used to deliver the said real-time interactive acknowledge request to the real-time interactive acknowledge request initiating module via SIP protocol.

The said data collection and synthesis station includes digital encoding and decoding modules, a TS stream editing and synthesis module, a private editing and synthesis module and a streaming media publishing module. The said digital encoding and decoding module converts audio-video analog signals collected into audio-video digital signals before synthetizing to TS stream signals using the said TS stream editing and synthetizing module, following which the digital signals are entered in the digital encoding & decoding module for re-coding, and the re-coded audio-video signals are output to the said streaming media publishing module for publication.

The said digital collection and synthesis station also includes a audio-video request module used to initiate the real-time interactive acknowledge request.

The system of this invention also includes a streaming publishing client connected sequentially with the data output of the said data collection and synthesis station, a streaming server and a streaming player client;

The said streaming publishing client is used to read the publishing signals from the said data collection and synthesis station, and package and partition the streaming media according to various size, format and system needs; upload the partitioned streaming and output the corresponding time axis data through HTTP or a private protocol;

The said streaming server combines and store partitioned streaming into streaming segments, and create indexes corresponding to several streaming segment sequences; deliver the streaming segments and indexes and output the corresponding time axis data;

The said streaming player client is used to download streaming segments according to index sequence for playing;

The said streaming publishing client delivers the audio-video signals and the corresponding time axis data to the said streaming player client for playing through the said streaming server, and the said interactive acknowledge publishing client reads and calls the audio-video signals output by the said data collection and synthesis station and the corresponding time axis data which are delivered to the said interactive acknowledge client via the said interactive acknowledge server, and then the said interactive acknowledge client activates the interactive acknowledge logic or activates it in a real-time manner according to the preset time axis logic after comparing the streaming play time axis of the said streaming player client with the time axis delivered by the said interactive acknowledge server, and the said interactive acknowledge client reports the users' acknowledge data to the data collection & synthesis station.

The present invention also discloses an interactive acknowledge method based on internet communications and streaming media live broadcast, which is based on an interactive acknowledge system based on internet communications and streaming media live broadcast, comprising an interactive acknowledge publishing client, an interactive acknowledge server and an interactive acknowledge client, wherein: it includes the following steps:

A: The said interactive acknowledge publishing client defines and edits the interactive acknowledge logic used for interactions or sends out the real-time interactive acknowledge request used for interactions, sets the said interactive acknowledge logic or the delivery strategy for the said real-time interactive acknowledge request, and transmits the said interactive acknowledge logic or the real-time acknowledge request and the delivery strategy to the said interactive acknowledge server;

B: The interactive acknowledge server receives the said interactive acknowledge logic or the real-time interactive acknowledge request and the deliver strategy, verifies and judges the said delivery strategy and delivers the said interactive acknowledge logic or the said real-time acknowledge request to the said interactive acknowledge client according to the verified delivery strategy;

C: The interactive acknowledge client receives the said interactive acknowledge logic or the real-time acknowledge request, and trigger the said interactive acknowledge logic or the said real-time interactive acknowledge request according to the triggering conditions, and collects and reports the acknowledge data in respect of the said interactive acknowledge logic or the said real-time interactive acknowledge request.

A preferred method, wherein the said Steps A-C include:

A1: The interactive acknowledge publishing client predefines and pre-edits the interactive acknowledge logic used for interactions, sets the said the delivery strategy for the said interactive acknowledge logic, and transmits the said interactive acknowledge logic and the delivery strategy to the said interactive acknowledge server;

B1: The interactive acknowledge server receives the said interactive acknowledge logic and the deliver strategy, verifies and judges the said delivery strategy and delivers the said interactive acknowledge logic to the said interactive acknowledge client according to the verified delivery strategy;

C1: The interactive acknowledge client receives and pre-store the said interactive acknowledge logic; the said interactive acknowledge publishing client read the audio-video signals and the time axis data to which the audio-video signals correspond and upload the said time axis data to the interactive acknowledge server which in turn delivers the time axis data to the interactive acknowledge client according to the delivery strategy stored and verified, and the said interactive acknowledge client triggers the said pre-stored interactive acknowledge logic according to the time axis data received, and collects and reports the acknowledge data in respect of the said interactive acknowledge logic.

A preferred method, wherein the said Steps A-C include:

A2: The interactive acknowledge publishing client receives and sends the real-time interactive acknowledge request used for interactions, and uploads the said real-time interactive acknowledge request and the delivery strategy to the said interactive acknowledge server;

The interactive acknowledge server receives the said real-time interactive acknowledge request and the deliver strategy uploaded, verifies and judges the said delivery strategy and delivers the said real-time interactive acknowledge request to the said interactive acknowledge client according to the verified delivery strategy;

C2: The interactive acknowledge client receives and triggers the interactive acknowledge request, collects and reports the acknowledge data in respect to the said real-time interactive acknowledge request.

The said Step A also includes Step A0: collect multi-input source data and output such data after edited, processed and synthetized in a real-time manner together with the time axis data to the said interactive acknowledge publishing client, or send the real-time acknowledge request to the said interactive acknowledge publishing client via SIP protocol.

What is preferred also includes Step D: collect the reported acknowledge data and the time axis data and compare the time axis data delivered with the time axis data reported to control the time lag.

In contrast with the existing technology, this invention has the following beneficial technical outcomes: 1. An interactive acknowledge editing and initiating module is used to edit the interactive acknowledge logic or send the real-time interactive acknowledge request, and the interactive acknowledge logic or the real-time interactive acknowledge request is delivered to the interactive acknowledge client by the interactive acknowledge server and triggered according to the triggering condition to collect and report the acknowledge data, thus providing a good interaction between the live broadcast site and the audience; 2. By comparing the time axis data delivered and the time axis reported, the time delay can be better controlled.

### NOTES ON ACCOMPANYING FIGURES

FIG. 1 is a block schematic diagram of the existing internet-based streaming media live broadcast system;

FIG. 2 is a block schematic diagram of the system of the present invention;

FIG. 3 is a flow chart of the present invention;

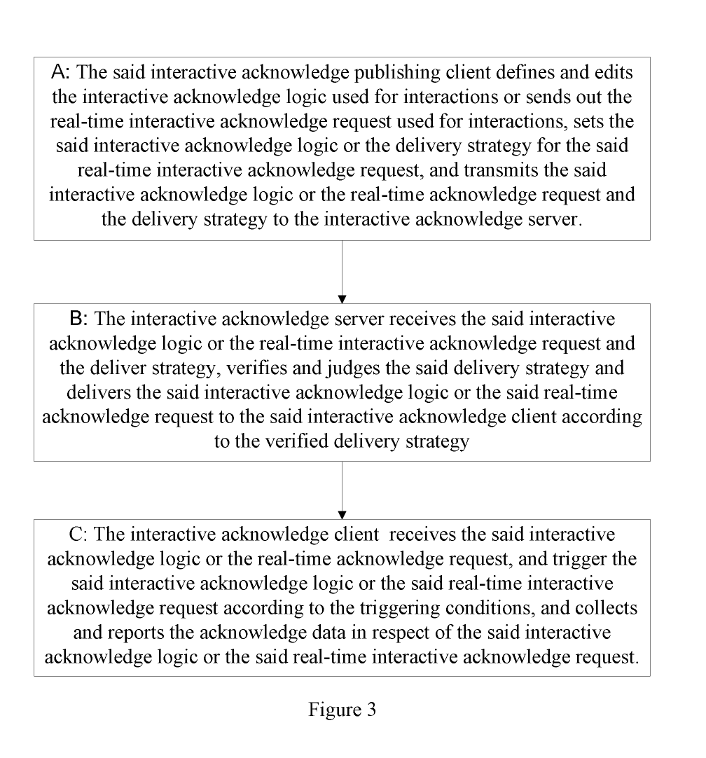

FIG. 4 is a block schematic diagram of a combination of the invention and the streaming media live broadcast system;

FIG. 5 is a block schematic diagram of a streaming media live broadcast system based on the system of the present invention;

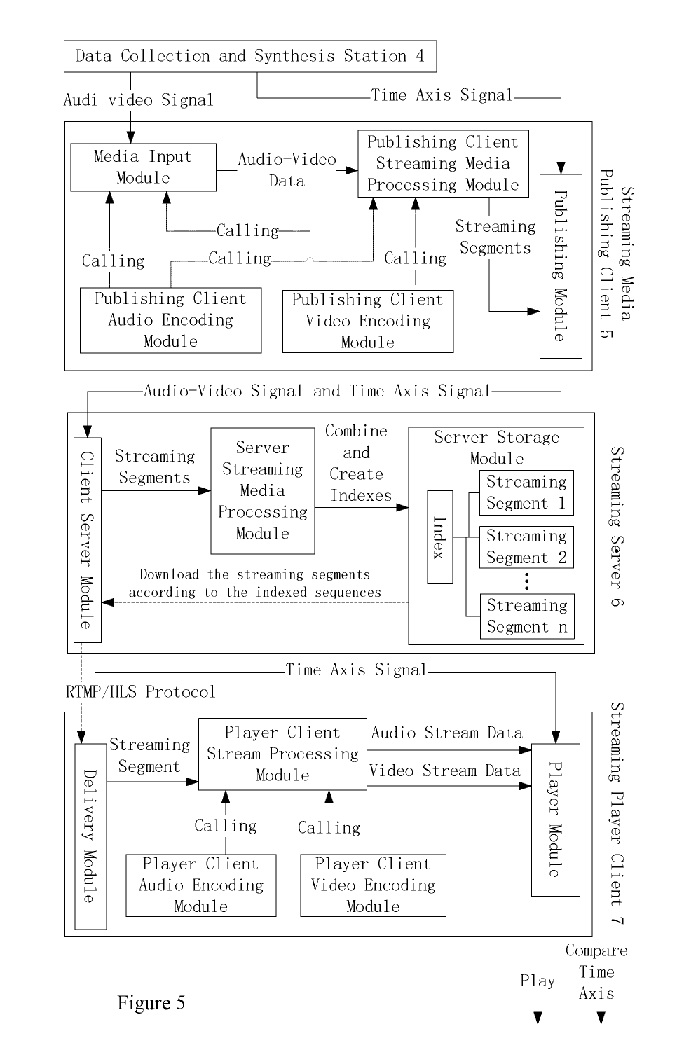

FIG. 6 is a block schematic diagram of the data collection and synthesis station in the present invention;

FIG. 7 is a time-sequence diagram when handshake is established using the Websocket protocol in the present invention;

FIG. 8 is a schematic diagram of the Websocket communication in the present invention.

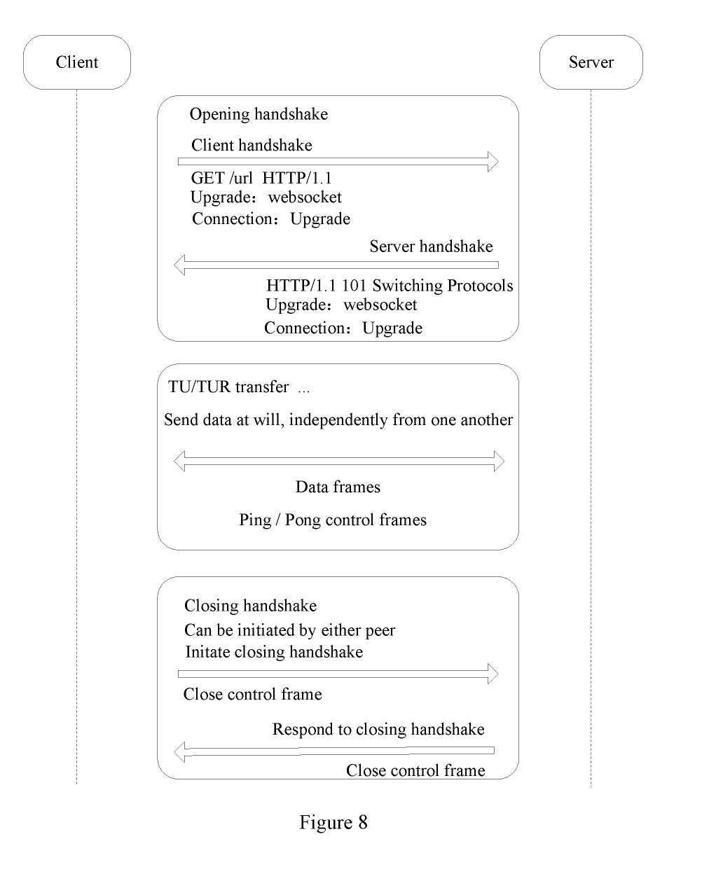

### PREFERRED EMBODIMENT

The following will further describe the present invention based on the accompanying figures and the preferred embodiments.

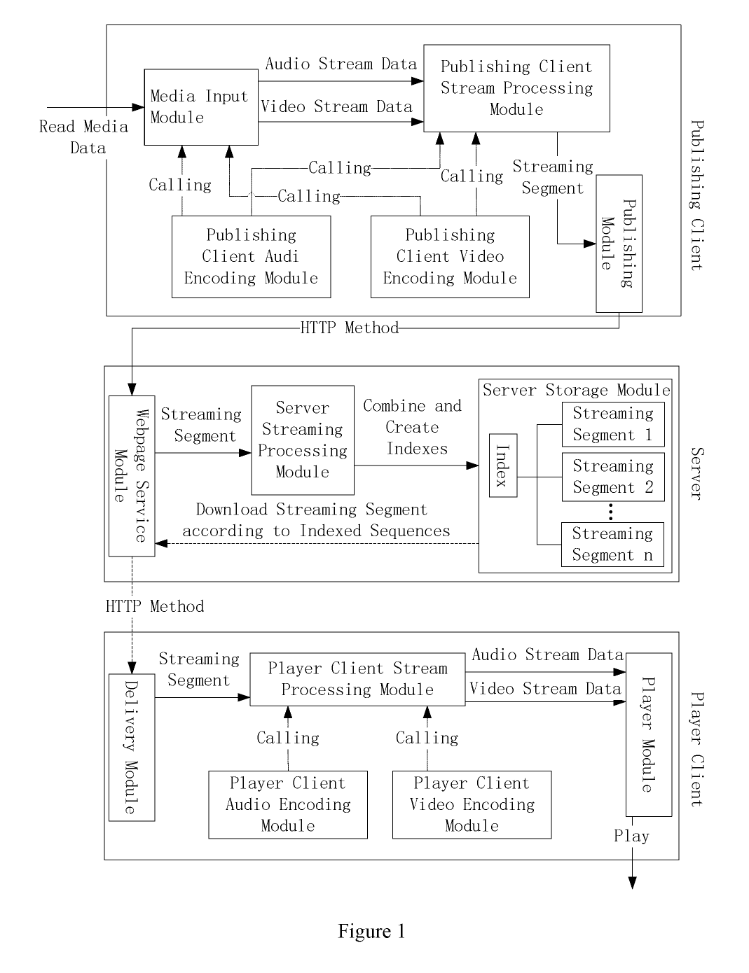

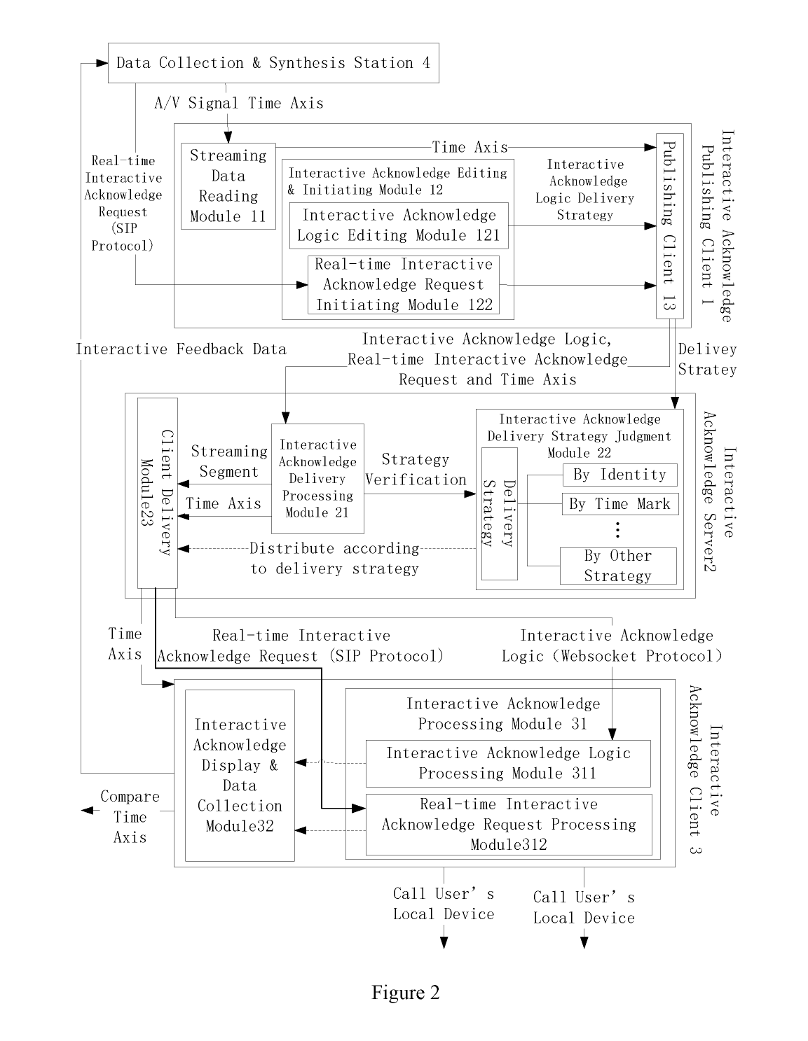

As shown in FIG. 1, the existing internet-based streaming media live broadcast system includes a publishing client, a server and a player client. As shown in FIG. 2, the present invention discloses an interactive acknowledge system based on internet communications and streaming media live broadcast, comprising an interactive acknowledge publishing client 1, an interactive acknowledge server 2, an interactive acknowledge client 3 and a data collection and synthesis station 4.

The interactive acknowledge publishing client 1 controls the edition and publication of the overall interactive acknowledge logic and specific interactive acknowledge logic. The interactive acknowledge logic is highly relative to the contents of live audio-video signals, which can be either predefined or published in a real-time manner; the automatic trigger mode can be set according to the time axis settings for the audio-video signals to be broadcast, or manual trigger may also be available. In addition, group messaging function is also available to all online users or to specific or particular users. After the live program is started, the interactive acknowledge publishing client 1 will read the audio-video signals and the corresponding time axis data, and trigger the interactive acknowledge logic or deliver the real-time acknowledge request in a real-time manner automatically according to the time axis.

The said interactive acknowledge publishing client 1 comprises: a streaming media data reading module 11, an interactive acknowledge editing and initiating module 12 and a publishing module 13.

The said streaming media data reading module 11 is used to read audio-video signals from the said data collection and synthesis station 4 and the time axis data corresponding to the audio-video signals.

The said interactive acknowledge editing and initiating module is used to define and edit the interactive acknowledge logic for interaction or send a real-time interactive acknowledge request for interaction, and set the said interactive acknowledge logic or the delivery strategy for the real-time interactive acknowledge request. The interactive acknowledge logic can be pre-edited words, data, pictures, questionnaire or tasks; the real-time interactive acknowledge request can be a piece of real-time voice, video interactive request, etc. The delivery strategy is the way how the defined and edited interactive acknowledge logic or the real-time interactive acknowledge request sent is delivered to the interactive acknowledge client 3. For example, to deliver to various interactive acknowledge clients 3 by ID or time mark or other delivery strategy.

The said publishing module 13 is used to upload the said interactive acknowledge logic or the said real-time interactive acknowledge request, the delivery strategy and the time axis data to the said interactive acknowledge server 2. The publishing module 13 receives the interactive acknowledge logic sent by the interactive acknowledge logic editing module 121 and the corresponding delivery strategy, receives the real-time interactive acknowledge request and the delivery strategy sent by the real-time interactive acknowledge request module 122 and the time axis data sent by the streaming media data reading module 11, and publish the said data received to the interactive acknowledge client 2.

The said interactive acknowledge editing and initiating module 12 further includes: an interactive acknowledge logic editing module 121 and a real-time interactive acknowledge request initiating module 122; the said interactive acknowledge logic editing module 121 is used to predefine and pre-edit the interactive acknowledge logic used for interaction, set the delivery strategy for the said interactive acknowledge logic and deliver the said interactive acknowledge logic and the deliver strategy; the real-time interactive acknowledge request initiating module 122 is used to receive and send the real-time interactive acknowledge request used for interaction.

The said interactive acknowledge server 2 includes: an interactive acknowledge delivery processing module 21, an interactive acknowledge delivery strategy judgement module 22 and a client delivery module 23; the said interactive acknowledge delivery processing module 21 is used to receive the said interactive acknowledge logic or the real-time interactive acknowledge request and the time axis data uploaded; the said interactive acknowledge delivery strategy judgement module 22 is used to receive the said delivery strategy uploaded and to verify and judge the delivery strategy; the client delivery module 23 is used to deliver the said interactive acknowledge logic or the real-time interactive acknowledge request and the time axis data to the interactive acknowledge client 3. For a preferred embodiment, the said interactive acknowledge client 2 delivers the time axis data to the interactive acknowledge client 3 through HTTP. It is understandable that the way that the said interactive acknowledge client 2 delivers the time axis data is not subject to this invention.

The said interactive acknowledge client 3 includes: an interactive processing module 31 and an interactive acknowledge display and data collection module 32; the said interactive acknowledge processing module 31 is used to receive the said interactive acknowledge logic or the real-time acknowledge request, and to trigger the interactive acknowledge logic or the real-time interactive acknowledge request according to the triggering conditions; the said interactive acknowledge display and data collection module 32 is used to receive the time axis data, collect and process the acknowledge data, and report the said acknowledge data and the time axis data to the said data collection and synthesis station. The reported acknowledge data may be either texts, pictures, local voices and videos or real-time voices, video recordings. For a preferred embodiment, the said interactive acknowledge display and data collection module 32 can report acknowledge data via HTTP. It is understandable that the way that the said interactive acknowledge display and data collection module 32 reports the acknowledge data is not subject to the HTTP method, and other existing feasible data transmission methods may also be used.

The interactive acknowledge processing module 31 further includes: an interactive acknowledge logic processing module 311 and a real-time interactive acknowledge request processing module 312. The said interactive acknowledge logic processing module 311 is used to trigger and save the said interactive acknowledge logic according to the time axis logic preset. The real-time interactive acknowledge request processing module 312 is used to process the real-time interactive acknowledge requests received in a real-time manner.

The interactive acknowledge client 3 can compare the time axis data received from the interactive acknowledge server 2 with the time axis data received from the streaming player client 3 to ensure the synchronization between the interactive acknowledge client 3 and the streaming player client 7 and to display the corresponding interactive acknowledge logic at the right time block.

The main working processes of the system of the present invention are: the said interactive acknowledge logic initiating module 12 defines and edits the interactive acknowledge logic used for interactions or sends out the real-time interactive acknowledge request used for interactions, sets the said interactive acknowledge logic or the delivery strategy for the said real-time interactive acknowledge request, and transmits the said interactive acknowledge logic or the real-time acknowledge request and the delivery strategy to the said publishing module 13 which uploads the said interactive acknowledge logic or the real-time acknowledge request and the delivery strategy to the said interactive acknowledge delivery processing module 21 and the interactive acknowledge delivery strategy judgement module 22; the said interactive acknowledge delivery strategy judgement module 22 receives the said delivery strategy uploaded, verifies and judges the delivery strategy and transmits the said delivery strategy to the said client delivery module 23, the said interactive acknowledge delivery processing module 21 receives the said interactive acknowledge logic or the real-time interactive acknowledge request and sends the said interactive acknowledge logic or the real-time interactive acknowledge request received to the said client delivery module 23, and the said client delivery module 23 delivers the said interactive acknowledge logic or the real-time interactive acknowledge request to the said interactive acknowledge client 3 according to the verified delivery strategy; the said interactive acknowledge processing module 31 receives the said interactive acknowledge logic or the real-time acknowledge request, and triggers the interactive acknowledge logic or the real-time interactive acknowledge request according to the triggering conditions, and transmits the acknowledge data to the said interactive acknowledge display and data collection module 32, and the said interactive acknowledge display and data collection module 32 collects and reports the acknowledge data in respect of the said interactive acknowledge logic or the said real-time interactive acknowledge request.

The first embodiment of the present invention is: the said interactive acknowledge editing and initiating module 12 includes an interactive acknowledge logic editing module 121, and the said interactive acknowledge processing module 31 includes an interactive acknowledge logic processing 311. The working process of the first embodiment is: the said interactive acknowledge logic editing module 121 predefines and pre-edits the interactive acknowledge logic used for interactions, sets the delivery strategy for the said interactive acknowledge logic and transmits the said interactive acknowledge logic and its delivery strategy to the said publishing module 13, and the said publishing module 13 uploads the said interactive acknowledge logic and its delivery strategy to the said interactive acknowledge server 2; the said interactive acknowledge delivery strategy judgement module 22 receives the delivery strategy uploaded, verifies and judges the said delivery strategy and send the verified delivery strategy to the said client delivery module 23. The said interactive acknowledge delivery processing module 21 receives the said interactive acknowledge logic uploaded and transmits the said interactive acknowledge logic received to the said client delivery module 23; the said client delivery module 23 delivers the said interactive acknowledge logic to the said interactive acknowledge logic processing module 311 according to the said delivery strategy verified; the said interactive acknowledge logic processing module 311 receives the said interactive acknowledge logic and pre-store it; the said streaming media data reading module 11 reads the audio-video signals and the time axis data corresponding to the audio-video signals and transfers the said time axis data to the said publishing module 13, and the said publishing module 13 transfers the said time axis data to the said interactive acknowledge server 2 which delivers the said time axis data to the said interactive acknowledge logic processing module 311 according to the delivery strategy stored after verification, and the said interactive acknowledge logic processing module 311 triggers the said interactive acknowledge logic according to the time axis data and report the acknowledge data in respect of the said interactive acknowledge logic to the said data collection and synthesis station 4.

The second embodiment of the present invention is: the said interactive acknowledge logic editing and initiating module 12 includes an real-time interactive acknowledge request initiating module 122, and the said interactive acknowledge processing module 31 includes a real-time interactive acknowledge request processing module 312. The working process of the second embodiment is that: the said real-time interactive acknowledge request initiating module 122 receives and sends the real-time interactive acknowledge request used for the interaction purpose to the said publishing module 13, and the said publishing module 13 uploads the real-time interactive acknowledge request received and the delivery strategy to the said interactive acknowledge server 2; the said interactive acknowledge server 2 receives the real-time interactive acknowledge request and the deliver strategy uploaded, verifies and judges the said delivery strategy and delivers the said real-time interactive acknowledge request to the said real-time interactive acknowledge request processing module 312 according to the said delivery strategy verified; the said real-time interactive acknowledge request processing module 312 receives and triggers the real-time interactive acknowledge request and reports the acknowledge data in respect of the said real-time interactive acknowledge request.

The system of the present invention has a data collection and synthesis station 4 used to collect multi-input source data and output such data after edited, processed and synthetized in a real-time manner together with the time axis data to the said streaming data reading module, or deliver the real-time acknowledge request to the said interactive acknowledge request initiating module 122 via SIP protocol.

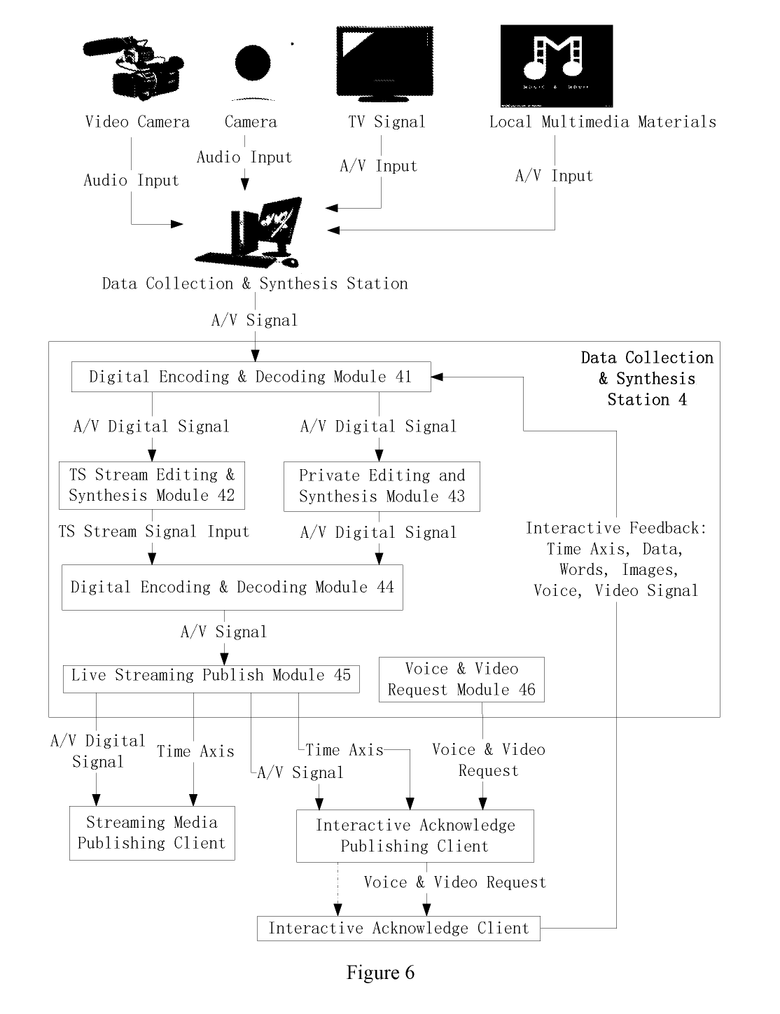

The data collection and synthesis station 4 is based on two kinds of technologies: one is the standard MPEG-TS system. The multi-channel signals are synthetized to standard MPEG-TS stream which will be output after entered. A standard MPEG-TS stream contains multi-channel digital signals, which is controlled by the data collection and synthesis station in a real-time manner, showing whether and when one or more channels of signals are displayed. The other technology is based on a private encoding and decoding algorithm. After decoding the digital signals input, words, images, audio and video outcomes will be then re-encoded, synthetized and output. As shown in FIG. 6, the said data collection and synthesis station 4 includes: digital encoding and decoding modules 41 and 44, A TS stream editing & synthesis module 42, a private editing and synthesis module 43 and a streaming media publishing module 45. The said digital encoding and decoding module 41 converts audio-video analog signals collected into audio-video digital signals before synthetizing to TS stream signals using the said TS stream editing and synthetizing module 43, following which the digital signals are entered in the digital encoding & decoding module 44 for re-coding, and the re-coded audio-video signals are output to the said streaming media publishing module 45 for publication. The said digital collection and synthesis station 4 also includes an audio-video request module 46 used to initiate the real-time interactive acknowledge request.

The data collection and synthesis station 4 can collection audio-video signals from connected camera, video camera, camera, television and mobile phone, local multimedia data or remote digital signals. The remote analog signals can also be put in the data collection and synthesis station 4 for editing and synthesis in the station 4 after encoded into digital signals through the video capture card.

The data collection and synthesis station 4 can edit and synthetize multi-channel audio-video signals on a real-time basis, which are output to the streaming media publishing client 5 together with the corresponding time axis data for publication, and the audio-video signals and the corresponding time axis data are output to the interactive acknowledge publishing client 1. The data collection and synthesis station 4 has a voice video request module 46 which can send the real-time interactive acknowledge request through the standard SIP protocol, and deliver the same to one or more users through the interactive acknowledge publishing client 1. After the user's acknowledge is confirmed, the interactive acknowledge client 3 will output the real-time audio and video signals reported by users or other types of signals to the data collection and synthesis station 4 for edition and synthesis at the station 4. The data collection and synthesis station 4 controls time lag by comparing the time axis delivery data and the collection time axis, to maximize the real-time and the effectiveness of the logic of the audio-video signals and interactive acknowledge signals.

The data collection and synthesis station 4 has the following features: 1. The data collection is made from multi-channels instead of single channel; 2. Signals are edited and synthetized using two encoding and decoding methods: standard and private to meet different output requirements; 3. The data collection and synthesis station controls the logic of audio-video signals, and controls the time lag by using the output and collection of time axis; 4. The data collection and synthesis station can send audio-video interactive requests through SIP protocol, and edit and synthetize real-time audio and video signals as one of the signal sources.

The system of the present invention adopts the Websocket protocol for the delivery of the interactive acknowledge logic. The WebSocket protocol is a two-way communication protocol, which is based on TCP and transfers data via TCP, similar with Http. However, there are two major differences between it and http: 1. Websocket is a two-way communication protocol that it's server and Browser/UA (namely UA browser) can actively send or receive data after the connection is established, just like a handshake, but the difference is that the WebSocket is a simple analog handshaking protocol based on web; 2. Websocket needs to establish the connection by handshake, just like TCP which also needs the handshake between the client and its server to perform communications after successful connection.

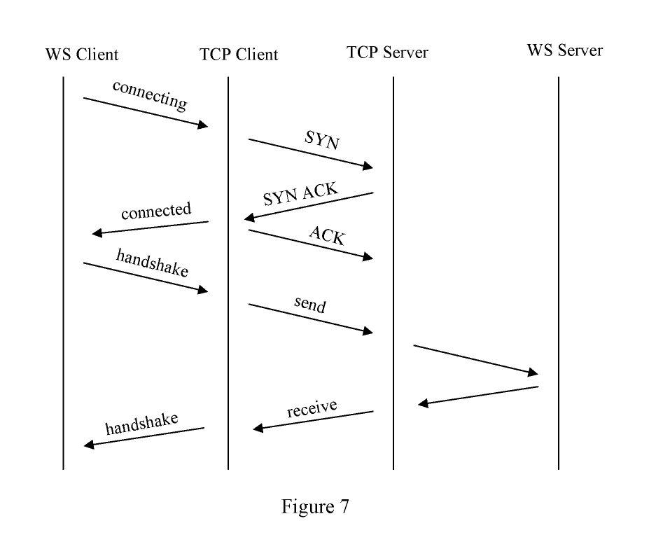

FIG. 7 is a time-sequence diagram when a handshake is established by the Websocket protocol. The WebSocket handshaking process is as follows:

When the web application calls a new WebSocket (url) interface, the Browser will start the process of establishing a handshake with Webserver whose address is url.
1. Browser and Websocket server establish connection through three times of handshake with TCP. If the connection fails, the subsequent process will not be performed, and the web application will receive a notification of wrong errors.
2. After the connection is successfully established through TCP, the Browser/UA transfers a serious of fields including Web Socket-supported version number, the version number of the protocol, original address and the host's address through http protocol, to the server.
3. If, after the WebSocket server receives the handshaking request from the Browser/US, the data and format of the data package are correct, and the protocol version numbers of the client and the servers can match each other, the handshaking request will be accepted, and the corresponding data reply will be given, which is also transferred through http protocol.
4. If, after the Browser receives the data packages replied by the serer, and the contents and format of the data packages are correct, it indicates the connection is successful, triggering the Onopen. The web developer can send data through the send interface. Otherwise, the handshake will fail, in which case the web application will receive the onerror message, and know the reason why the connection fails.

One of the advantages of the Web Socket technology is that one client can only use one TCP link and that the server can directly send the data to the client, thus resulting in small quantity of data and less load on data transportation, and that the client interface logic to be developed is simple and compatible.

This invention also discloses an interactive acknowledge method based on internet communications and streaming media live broadcast, which is based on an interactive acknowledge system based on internet communications and streaming media live broadcast, comprising an interactive acknowledge publishing client 1, an interactive acknowledge server 2 and an interactive acknowledge client 3, wherein: it includes the following steps:

A: The said interactive acknowledge publishing client 1 defines and edits the interactive acknowledge logic used for interactions or sends out the real-time interactive acknowledge request used for interactions, sets the said interactive acknowledge logic or the delivery strategy for the said real-time interactive acknowledge request, and transmits the said interactive acknowledge logic or the real-time acknowledge request and the delivery strategy to the said interactive acknowledge server 2;

B: The interactive acknowledge server 2 receives the said interactive acknowledge logic or the real-time interactive acknowledge request and the deliver strategy, verifies and judges the said delivery strategy and delivers the said interactive acknowledge logic or the said real-time acknowledge request to the said interactive acknowledge client 3 according to the verified delivery strategy;

C: The interactive acknowledge client 3 receives the said interactive acknowledge logic or the real-time acknowledge request, and trigger the said interactive acknowledge logic or the said real-time interactive acknowledge request according to the triggering conditions, and collects and reports the acknowledge data in respect of the said interactive acknowledge logic or the said real-time interactive acknowledge request.

The first embodiment of the method is:

A1: The interactive acknowledge publishing client 1 predefines and pre-edits the interactive acknowledge logic used for interactions, sets the said the delivery strategy for the said interactive acknowledge logic, and transmits the said interactive acknowledge logic and the delivery strategy to the said interactive acknowledge server 2;

B1: The interactive acknowledge server 2 receives the said interactive acknowledge logic and the deliver strategy, verifies and judges the said delivery strategy and delivers the said interactive acknowledge logic to the said interactive acknowledge client 3 according to the verified delivery strategy;

C1: The interactive acknowledge client 3 receives and pre-store the said interactive acknowledge logic; the said interactive acknowledge publishing client 1 reads the audio-video signals and the time axis data to which the audio-video signals correspond and upload the said time axis data to the interactive acknowledge server 2 which in turn delivers the time axis data to the interactive acknowledge client 3 according to the delivery strategy stored and verified, and the said interactive acknowledge client 3 triggers the said pre-stored interactive acknowledge logic according to the time axis data received, and collects and reports the acknowledge data in respect of the said interactive acknowledge logic.

The second embodiment of the method is:

A2: The interactive acknowledge publishing client 1 receives and sends the real-time interactive acknowledge request used for interactions, and uploads the said real-time interactive acknowledge request and the delivery strategy to the said interactive acknowledge server 2;

B2: The interactive acknowledge server 2 receives the said real-time interactive acknowledge request and the deliver strategy uploaded, verifies and judges the said delivery strategy and delivers the said real-time interactive acknowledge request to the said interactive acknowledge client 3 according to the verified delivery strategy;

C2: The interactive acknowledge client 3 receives and triggers the interactive acknowledge request, collects and reports the acknowledge data in respect to the said real-time interactive acknowledge request.

The method of the present invention also include a step A0 before Step A: collect multi-input source data and outputs such data after edited, processed and synthetized in a real-time manner together with the time axis data to the said interactive acknowledge publishing client 1, or send the real-time acknowledge request to the said interactive acknowledge publishing client 1 via SIP protocol. This invention also includes Step D: collect the reported acknowledge data and the time axis data and compare the time axis data delivered with the time axis data reported to control the time lag.

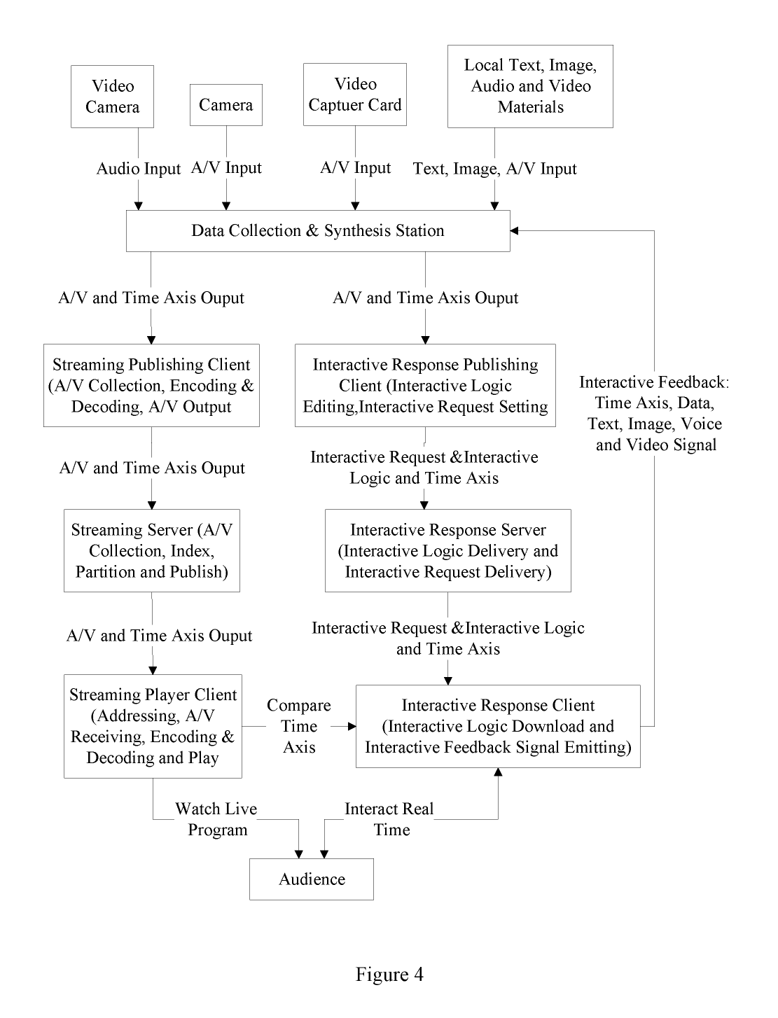

FIG. 4 is a schematic block diagram of one embodiment of the invention in combination with the internet-based streaming media live broadcast system. The data collection and synthesis station 4 edits and synthetize the audio-video signals collected to multi-channel audio-video signals, and outputs the synthetized audio-video signals to the streaming media publishing client 5 together with the corresponding time axis data, and outputs the synthetized audio-video signals and the corresponding time axis data to the interactive acknowledge publishing client 1.

The streaming media publishing client 5 delivers the corresponding time axis to the streaming player client 7 through the streaming server 6. The specific process is as follows: 1. The streaming media publishing client 5 reads the publishing signals from the said data collection and synthesis station 4, and package and partition the streaming media according to various size, format and system needs; upload the partitioned streaming to the streaming server 6 and output the corresponding time axis data through HTTP or a private protocol; 2. The said streaming server 6 combines and store partitioned streaming into streaming segments, and create indexes corresponding to several streaming segment sequences; deliver the streaming segments and indexes to the streaming player client 7 and output the corresponding time axis data; 3. The streaming player 7 interacts with the steaming server 6 and download the streaming segments according to the indexed sequence. By comparing the streaming segment data with the client's system time according to the time axis data delivered by the streaming server 6, the timeliness of the streaming segments can be ensued to the maximum extent.

The streaming media publishing client 5 delivers the corresponding time axis to the streaming player client through the streaming server 6, while the interactive acknowledge publishing client 1 reads and calls the audio-video signals and corresponding time axis data output by the data collection and synthesis station 4. The time axis data is delivered to the interactive acknowledge client 3 through the interactive acknowledge client 3 through the interactive acknowledge server 2, and the interactive acknowledge client 3 compares the streaming time axis of the streaming player client 7 with the time axis delivered by the interactive acknowledge server 2, and then the said interactive acknowledge client activates the interactive acknowledge logic or activates it in a real-time manner, and the said interactive acknowledge client 3 reports the users' acknowledge data to the data collection & synthesis station 4.

The structure of the above internet-based streaming media live broadcast system is not subject to the said description, and FIG. 4 only discloses one embodiment of the invention. The system of present invention can interact with other streaming media live broadcast systems with other structures.

The following examples describe the application of the system and method disclosed herein:

### Example 1

When the host interviews a star in a live program, the audience can interact with the program. The host can propose to vote the stars that the audiences prefer, such as Wang Fei, Li Yapeng or Dou Wei. The voting request provided by the host on site is an interactive acknowledge request, which will be uploaded to the interactive acknowledge request server 2 through the interactive acknowledge publishing client 1, and the interactive acknowledge server 2 furthers delivers the request to the interactive acknowledge client 3 so that the audience can vote after receipt of the request. The interactive acknowledge client 3 collects and reports the voting results, and the data collection and synthesis station 4 classifies and summarizes the reported data and send the data to the host and stars through the on-site director or by a projector in a real-time manner. The host and the stars can introduce the next topics according to the feedback given by the audience.

### Example III

In the case of live broadcasting of a hot event or major sports game through internet, the host or the director can collect the audience's opinions or make investigation in a real-time manner, and the audience can send their preferred opinions through the interactive acknowledge client. For example, an interactive acknowledge request is delivered by the interactive acknowledge client 1: “What's reason do you think that MH370 flight is lost? A. Failures appearing in mechanical and communication systems at the same time; B. The plane was hijacked by terrorists; C. The pilot shut down the communication system for some purpose; D. Other reasons; or “What result do you think will be obtained in the game of Bayern Munich vs. Manchester United”? A: Bayern Munich will win; B: They will get a draw; C. Manchester United will win. The interactive acknowledge server 2 receives the interactive acknowledge request and deliver such request to the interactive acknowledge client 3, while the interactive acknowledge client 3 collects and reports the feedbacks from the audience and send such data to the site through the data collection and synthesis station 4.

### Example III

When holding a singing contest, the host or the director may publish an interactive acknowledge logic according to the performance of the contestants to receive the corresponding acknowledge data. For example: “Who do you think will be promoted to the next game: A. Li Yuchun; B. Zhang Liangying; C. Zhou Bichang; D. He Jie”. This interactive acknowledge logic will preset through the interactive acknowledge publishing client 1 and delivered to the interactive acknowledge client 3 through the interactive acknowledge server 2, and then displayed on the interactive acknowledge client 3 by triggering by the host, and the site director may also sets an interactive request through the interactive acknowledge publishing client and deliver such request to the interactive acknowledge client 3 through the interactive acknowledge server. The audience can vote using the interactive acknowledge clients, and the relevant data will be reported to the data collection and synthesis station for summarization. For example, Li Yunchun wins 1200 votes, Zhang Liangying wins 900 votes, Zhou Bichang wins 800 votes and He Jie wins 600 votes. The voting results will be declared by the projector and the host on site to determine who will be promoted to the next game.

The system of the present invention can conveniently be built in the existing streaming media live broadcast systems and used together with such systems.

1: An interactive acknowledge system based on internet communications and streaming media live broadcast, comprising: a data collection and synthesis station (4), and also including: an interactive acknowledge publishing client (1), an interactive acknowledge server (4) and an interactive acknowledge client (3);
The said interactive acknowledge publishing client (1) comprises: a streaming media data reading module (11) used to read audio-video signals from the said data collection and synthesis station (4) and the time axis data corresponding to the audio-video signals; the said interactive acknowledge editing and initiating module (12) is used to define and edit the interactive acknowledge logic for interaction or send a real-time interactive acknowledge request for interaction, and set the said interactive acknowledge logic or the delivery strategy for the real-time interactive acknowledge request; the said publishing module (13) is used to upload the said interactive acknowledge logic or the said real-time interactive acknowledge request, the delivery strategy and the time axis data to the said interactive acknowledge server (2);
The said interactive acknowledge server (2) includes: an interactive acknowledge delivery processing module (21), an interactive acknowledge delivery strategy judgement module (22) and a client delivery module (23); the said interactive acknowledge delivery processing module (21) is used to receive the said interactive acknowledge logic or the real-time interactive acknowledge request and the time axis data uploaded; the said interactive acknowledge delivery strategy judgement module (22) is used to receive the said delivery strategy uploaded and to verify and judge the delivery strategy; the client delivery module (23) is used to deliver the said interactive acknowledge logic or the real-time interactive acknowledge request and the time axis data to the interactive acknowledge client (3);
The said interactive acknowledge client (3) includes: an interactive processing module (31) and an interactive acknowledge display and data collection module (32); the said interactive acknowledge processing module (31) is used to receive the said interactive acknowledge logic or the real-time acknowledge request, and to trigger the interactive acknowledge logic or the real-time interactive acknowledge request according to the triggering conditions; the said interactive acknowledge display and data collection module (32) is used to receive the time axis data, collect and process the acknowledge data, and report the said acknowledge data and the time axis data to the said data collection and synthesis station (4).

2: An interactive acknowledge system based on internet communications and streaming media live broadcast as defined in claim 1, wherein: the said interactive acknowledge editing and initiating module (12) defines and edits the interactive acknowledge logic used for interactions or sends out the real-time interactive acknowledge request used for interactions, sets the said interactive acknowledge logic or the delivery strategy for the said real-time interactive acknowledge request, and transmits the said interactive acknowledge logic or the real-time acknowledge request and the delivery strategy to the said publishing module (13) which will upload the said interactive acknowledge logic or the real-time interactive acknowledge request and the delivery strategy to the said interactive acknowledge delivery processing module (21) and the interactive acknowledge delivery strategy judgement module (22); the said interactive acknowledge delivery strategy judgement module receives the delivery strategy uploaded, verifies and judges the said strategy and send it to the said client delivery module (23) after verification, and the said interactive acknowledge delivery processing module (21) receives the said interactive acknowledge logic or the real-time interactive acknowledge request uploaded and send such interactive acknowledge logic or such real-time acknowledge request received to the said client delivery module (23) which will deliver the said interactive acknowledge logic or the real-time interactive acknowledge request to the said interactive acknowledge client (3) according to the verified delivery strategy; the said interactive acknowledge processing module (31) receives the said interactive acknowledge logic or the real-time acknowledge request and triggers the said interactive acknowledge logic or the real-time acknowledge request according to the triggering conditions and transmit the acknowledge data to the said interactive acknowledge display and data collection module (32) which is used to receive the time axis data, collect and process acknowledge data and report the said time axis data and the acknowledge data to the said data collection and synthesis station (4).

3: An interactive acknowledge system based on internet communications and streaming media live broadcast as defined in claim 1, wherein: the said interactive acknowledge logic editing and initiating module (12) includes an interactive acknowledge logic editing module (121), and the said interactive acknowledge processing module (31) including an interactive acknowledge logic processing module (131).
The said interactive acknowledge logic editing module (121) predefines and pre-edits the interactive acknowledge logic used for interactions, sets the delivery strategy for the said interactive acknowledge logic and transmits the said interactive acknowledge logic and its delivery strategy to the said publishing module (13), and the said publishing module (13) uploads the said interactive acknowledge logic and its delivery strategy to the said interactive acknowledge server (2); the said interactive acknowledge delivery strategy judgement module (22) receives the delivery strategy uploaded, verifies and judges the said delivery strategy and send the verified delivery strategy to the said client delivery module (23). The said interactive acknowledge delivery processing module (21) receives the said interactive acknowledge logic uploaded and transmits the said interactive acknowledge logic received to the said client delivery module (23); the said client delivery module (23) delivers the said interactive acknowledge logic to the said interactive acknowledge logic processing module (311) according to the said delivery strategy verified; the said interactive acknowledge logic processing module (311) receives the said interactive acknowledge logic and pre-store it; the said streaming media data reading module (11) reads the audio-video signals and the time axis data corresponding to the audio-video signals and transfers the said time axis data to the said publishing module (13), and the said publishing module (13) transfers the said time axis data to the said interactive acknowledge server (2) which delivers the said time axis data to the said interactive acknowledge logic processing module (311) according to the delivery strategy stored after verification, and the said interactive acknowledge logic processing module (311) triggers the said interactive acknowledge logic according to the time axis data and report the acknowledge data in respect of the said interactive acknowledge logic to the said data collection and synthesis station (4).

4: An interactive acknowledge system based on internet communications and streaming media live broadcast as defined in claim 1, wherein: the said interactive acknowledge logic editing and initiating module (12) includes an real-time interactive acknowledge request initiating module (122), and the said interactive acknowledge processing module (31) includes a real-time interactive acknowledge request processing module (312); the said real-time interactive acknowledge request initiating module (122) receives and sends the real-time interactive acknowledge request used for the interaction purpose to the said publishing module (13), and the said publishing module (13) upload the real-time interactive acknowledge request received and the delivery strategy to the said interactive acknowledge server (2); the said interactive acknowledge server (2) receives the real-time interactive acknowledge request and the deliver strategy uploaded, verifies and judges the said delivery strategy and delivers the said real-time interactive acknowledge request to the said real-time interactive acknowledge request processing module (312) according to the said delivery strategy verified; the said real-time interactive acknowledge request processing module (312) receives and triggers the real-time interactive acknowledge request and reports the acknowledge data in respect of the said real-time interactive acknowledge request to the said data collection and synthesis station (4).

5: An interactive acknowledge system based on internet communications and streaming media live broadcast as defined in claim 1, wherein: the said data collection and synthesis station (4) is used to collect multi-input source data and to output such data after edited, processed and synthetized in a real-time manner together with the time axis data to the said streaming media data reading module (11), or used to deliver the said real-time interactive acknowledge request to the real-time interactive acknowledge request initiating module (122) via SIP protocol.

6: An interactive acknowledge system based on internet communications and streaming media live broadcast as defined in claim 5, wherein: the said data collection and synthesis station (4) includes digital encoding and decoding modules (41, 44), a TS stream editing and synthesis module (42), a private editing and synthesis module (43) and a streaming media publishing module (44). The said digital encoding and decoding module (41) converts audio-video analog signals collected into audio-video digital signals before synthetizing to TS stream signals using the said TS stream editing and synthetizing module (43), following which the digital signals are entered in the digital encoding & decoding module (44) for re-coding, and the re-coded audio-video signals are output to the said streaming media publishing module (45) for publication.
The said digital collection and synthesis station (4) also includes an audio-video request module (46) used to initiate the real-time interactive acknowledge request.

7: An interactive acknowledge system based on internet communications and streaming media live broadcast as defined in any of claims claim 1, wherein: it includes a streaming publishing client (5) connected sequentially with the data output of the said data collection and synthesis station (4), a streaming server (6) and a streaming player client (7);
The said streaming publishing client (5) is used to read the publishing signals from the said data collection and synthesis station (4), and package and partition the streaming media according to various size, format and system needs; upload the partitioned streaming and output the corresponding time axis data through HTTP or a private protocol;
The said streaming server (6) combines and store partitioned streaming into streaming segments, and create indexes corresponding to several streaming segment sequences; deliver the streaming segments and indexes and output the corresponding time axis data;
The said streaming player client (7) is used to download streaming segments according to index sequence for playing;
The said streaming publishing client (5) delivers the audio-video signals and the corresponding time axis data to the said streaming player client (7) for playing through the said streaming server (6), and the said interactive acknowledge publishing client (1) reads and calls the audio-video signals output by the said data collection and synthesis station (4) and the corresponding time axis data which are delivered to the said interactive acknowledge client (3) via the said interactive acknowledge server (2), and then the said interactive acknowledge client (3) activates the interactive acknowledge logic or activates it in a real-time manner according to the preset time axis logic after comparing the streaming play time axis of the said streaming player client (7) with the time axis delivered by the said interactive acknowledge server (2), and the said interactive acknowledge client (3) reports the users' acknowledge data to the data collection & synthesis station (4).

8: An interactive acknowledge method based on internet communications and streaming media live broadcast is based on an interactive acknowledge system based on internet communications and streaming media live broadcast, which comprises an interactive acknowledge publishing client (1), an interactive acknowledge server (2) and an interactive acknowledge client (3), wherein: it includes the following steps:
A: The said interactive acknowledge publishing client (1) defines and edits the interactive acknowledge logic used for interactions or sends out the real-time interactive acknowledge request used for interactions, sets the said interactive acknowledge logic or the delivery strategy for the said real-time interactive acknowledge request, and transmits the said interactive acknowledge logic or the real-time acknowledge request and the delivery strategy to the said interactive acknowledge server (2);
B: The interactive acknowledge server (2) receives the said interactive acknowledge logic or the real-time interactive acknowledge request and the deliver strategy, verifies and judges the said delivery strategy and delivers the said interactive acknowledge logic or the said real-time acknowledge request to the said interactive acknowledge client (3) according to the verified delivery strategy;
C: The interactive acknowledge client (3) receives the said interactive acknowledge logic or the real-time acknowledge request, and trigger the said interactive acknowledge logic or the said real-time interactive acknowledge request according to the triggering conditions, and collects and reports the acknowledge data in respect of the said interactive acknowledge logic or the said real-time interactive acknowledge request.

9: An interactive acknowledge method based on internet communications and streaming media live broadcast as described in claim 8, wherein: the said Steps A-C include:
Step A1: The interactive acknowledge publishing client (1) predefines and pre-edits the interactive acknowledge logic used for interactions, sets the said the delivery strategy for the said interactive acknowledge logic, and transmits the said interactive acknowledge logic and the delivery strategy to the said interactive acknowledge server (2);
Step B1: The interactive acknowledge server (2) receives the said interactive acknowledge logic and the deliver strategy, verifies and judges the said delivery strategy and delivers the said interactive acknowledge logic to the said interactive acknowledge client (3) according to the verified delivery strategy;
Step C1: The interactive acknowledge client (3) receives and pre-store the said interactive acknowledge logic; the said interactive acknowledge publishing client (1) read the audio-video signals and the time axis data to which the audio-video signals correspond and upload the said time axis data to the interactive acknowledge server (2) which in turn delivers the time axis data to the interactive acknowledge client (3) according to the delivery strategy stored and verified, and the said interactive acknowledge client (3) triggers the said pre-stored interactive acknowledge logic according to the time axis data received, and collects and reports the acknowledge data in respect of the said interactive acknowledge logic.

10: An interactive acknowledge method based on internet communications and streaming media live broadcast as described in claim 8, wherein: the said Steps A-C include:
Step A2: The interactive acknowledge publishing client (1) receives and sends the real-time interactive acknowledge request used for interactions, and uploads the said real-time interactive acknowledge request and the delivery strategy to the said interactive acknowledge server (2);
Step B2: The interactive acknowledge server (2) receives the said real-time interactive acknowledge request and the deliver strategy uploaded, verifies and judges the said delivery strategy and delivers the said real-time interactive acknowledge request to the said interactive acknowledge client (3) according to the verified delivery strategy;
Step C2: The interactive acknowledge client (3) receives and triggers the interactive acknowledge request, collects and reports the acknowledge data in respect to the said real-time interactive acknowledge request.

11: An interactive acknowledge method based on internet communications and streaming media live broadcast as described in claim 8, wherein it also includes Step A0 before the said Step A: collects multi-input source data and outputs such data after edited, processed and synthetized in a real-time manner together with the time axis data to the said interactive acknowledge publishing client (1), or sends the real-time acknowledge request to the said interactive acknowledge publishing client (1) via SIP protocol.

12: An interactive acknowledge method based on internet communications and streaming media live broadcast as described in claim 8, wherein it also includes Step D: collect the reported acknowledge data and the time axis data and compare the time axis data delivered with the time axis data reported to control the time lag.

13: An interactive acknowledge system based on internet communications and streaming media live broadcast as described in claim 2, wherein it further includes: a streaming publishing client (5) connected sequentially with the data output of the said data collection and synthesis station (4), a streaming server (6) and a streaming player client (7);
The said streaming publishing client (5) is used to read the publishing signals from the said data collection and synthesis station (4), and package and partition the streaming media according to various sizes, format and system needs; upload the partitioned streaming and output the corresponding time axis data through HTTP or a private protocol;
The said streaming server (6) combines and store partitioned streaming into streaming segments, and create indexes corresponding to several streaming segment sequences; deliver the streaming segments and indexes and output the corresponding time axis data;
The said streaming player client (7) is used to download streaming segments according to index sequence for playing;
The said streaming publishing client (5) delivers the audio-video signals and the corresponding time axis data to the said streaming player client (7) for playing through the said streaming server (6), and the said interactive acknowledge publishing client (1) reads and calls the audio-video signals output by the said data collection and synthesis station (4) and the corresponding time axis data which are delivered to the said interactive acknowledge client (3) via the said interactive acknowledge server (2), and then the said interactive acknowledge client (3) activates the interactive acknowledge logic or activates it in a real-time manner according to the preset time axis logic after comparing the streaming play time axis of the said streaming player client (7) with the time axis delivered by the said interactive acknowledge server (2), and the said interactive acknowledge client (3) reports the users' acknowledge data to the data collection & synthesis station (4).

14: An interactive acknowledge system based on internet communications and streaming media live broadcast as described in claim 3, wherein it further includes: a streaming publishing client (5) connected sequentially with the data output of the said data collection and synthesis station (4), a streaming server (6) and a streaming player client (7);
The said streaming publishing client (5) is used to read the publishing signals from the said data collection and synthesis station (4), and package and partition the streaming media according to various sizes, format and system needs; upload the partitioned streaming and output the corresponding time axis data through HTTP or a private protocol;
The said streaming server (6) combines and store partitioned streaming into streaming segments, and create indexes corresponding to several streaming segment sequences; deliver the streaming segments and indexes and output the corresponding time axis data;
The said streaming player client (7) is used to download streaming segments according to index sequence for playing;
The said streaming publishing client (5) delivers the audio-video signals and the corresponding time axis data to the said streaming player client (7) for playing through the said streaming server (6), and the said interactive acknowledge publishing client (1) reads and calls the audio-video signals output by the said data collection and synthesis station (4) and the corresponding time axis data which are delivered to the said interactive acknowledge client (3) via the said interactive acknowledge server (2), and then the said interactive acknowledge client (3) activates the interactive acknowledge logic or activates it in a real-time manner according to the preset time axis logic after comparing the streaming play time axis of the said streaming player client (7) with the time axis delivered by the said interactive acknowledge server (2), and the said interactive acknowledge client (3) reports the users' acknowledge data to the data collection & synthesis station (4).

15: An interactive acknowledge system based on internet communications and streaming media live broadcast as described in claim 4, wherein it further includes: a streaming publishing client (5) connected sequentially with the data output of the said data collection and synthesis station (4), a streaming server (6) and a streaming player client (7);
The said streaming publishing client (5) is used to read the publishing signals from the said data collection and synthesis station (4), and package and partition the streaming media according to various sizes, format and system needs; upload the partitioned streaming and output the corresponding time axis data through HTTP or a private protocol;
The said streaming server (6) combines and store partitioned streaming into streaming segments, and create indexes corresponding to several streaming segment sequences; deliver the streaming segments and indexes and output the corresponding time axis data;
The said streaming player client (7) is used to download streaming segments according to index sequence for playing;
The said streaming publishing client (5) delivers the audio-video signals and the corresponding time axis data to the said streaming player client (7) for playing through the said streaming server (6), and the said interactive acknowledge publishing client (1) reads and calls the audio-video signals output by the said data collection and synthesis station (4) and the corresponding time axis data which are delivered to the said interactive acknowledge client (3) via the said interactive acknowledge server (2), and then the said interactive acknowledge client (3) activates the interactive acknowledge logic or activates it in a real-time manner according to the preset time axis logic after comparing the streaming play time axis of the said streaming player client (7) with the time axis delivered by the said interactive acknowledge server (2), and the said interactive acknowledge client (3) reports the users' acknowledge data to the data collection & synthesis station (4).

16: An interactive acknowledge system based on internet communications and streaming media live broadcast as described in claim 5, wherein it further includes: a streaming publishing client (5) connected sequentially with the data output of the said data collection and synthesis station (4), a streaming server (6) and a streaming player client (7);
The said streaming publishing client (5) is used to read the publishing signals from the said data collection and synthesis station (4), and package and partition the streaming media according to various sizes, format and system needs; upload the partitioned streaming and output the corresponding time axis data through HTTP or a private protocol;
The said streaming server (6) combines and store partitioned streaming into streaming segments, and create indexes corresponding to several streaming segment sequences; deliver the streaming segments and indexes and output the corresponding time axis data;
The said streaming player client (7) is used to download streaming segments according to index sequence for playing;
The said streaming publishing client (5) delivers the audio-video signals and the corresponding time axis data to the said streaming player client (7) for playing through the said streaming server (6), and the said interactive acknowledge publishing client (1) reads and calls the audio-video signals output by the said data collection and synthesis station (4) and the corresponding time axis data which are delivered to the said interactive acknowledge client (3) via the said interactive acknowledge server (2), and then the said interactive acknowledge client (3) activates the interactive acknowledge logic or activates it in a real-time manner according to the preset time axis logic after comparing the streaming play time axis of the said streaming player client (7) with the time axis delivered by the said interactive acknowledge server (2), and the said interactive acknowledge client (3) reports the users' acknowledge data to the data collection & synthesis station (4).

17: An interactive acknowledge system based on internet communications and streaming media live broadcast as described in claim 6, wherein it further includes: a streaming publishing client (5) connected sequentially with the data output of the said data collection and synthesis station (4), a streaming server (6) and a streaming player client (7);
The said streaming publishing client (5) is used to read the publishing signals from the said data collection and synthesis station (4), and package and partition the streaming media according to various sizes, format and system needs; upload the partitioned streaming and output the corresponding time axis data through HTTP or a private protocol;
The said streaming server (6) combines and store partitioned streaming into streaming segments, and create indexes corresponding to several streaming segment sequences; deliver the streaming segments and indexes and output the corresponding time axis data;
The said streaming player client (7) is used to download streaming segments according to index sequence for playing;
The said streaming publishing client (5) delivers the audio-video signals and the corresponding time axis data to the said streaming player client (7) for playing through the said streaming server (6), and the said interactive acknowledge publishing client (1) reads and calls the audio-video signals output by the said data collection and synthesis station (4) and the corresponding time axis data which are delivered to the said interactive acknowledge client (3) via the said interactive acknowledge server (2), and then the said interactive acknowledge client (3) activates the interactive acknowledge logic or activates it in a real-time manner according to the preset time axis logic after comparing the streaming play time axis of the said streaming player client (7) with the time axis delivered by the said interactive acknowledge server (2), and the said interactive acknowledge client (3) reports the users' acknowledge data to the data collection & synthesis station (4).
